(19) United States
(12) Patent Application Publication
(10) Pub. No.: US 2012/0029135 A1
(43) Pub. Date: Feb. 2, 2012

(54) Polyphenylene Sulfide Synthetic Hair Filaments And Processes For Preparing The Same

(75) Inventors: Jong Chun Kim, Chunbuk (KR); Hwan Chul Kim, Chunbuk (KR); Chan Young Kim, Chunbuk (KR); Seung Min Oh, Chunbuk (KR)

(73) Assignee: UNO & COMPANY LTD., Chunbuk (KR)

(21) Appl. No.: 12/899,612

(22) Filed: Oct. 7, 2010

(30) Foreign Application Priority Data
Jul. 30, 2010 (KR) 2010-73748

(51) Int. Cl. C08K 3/34; B29C 47/90; C08K 3/36; C08L 81/04

(52) U.S. Cl. 524/451; 524/609; 264/164; 524/493

(57) ABSTRACT

The present invention provides a polyphenylene sulfide synthetic hair filament. The synthetic hair filament comprises (A) a polyphenylene sulfide resin; and (B) an inorganic particle quencher additive, wherein said PPS resin melt index range is 60˜110, wherein said inorganic quencher additive is added at 0.1˜2.0 parts by weight on a 100 parts by weight PPS resin. The synthetic hair filament has a filament size of about 30 to about 80 dtex. The polyphenylene sulfide resin (A) has a p-phenylene sulfide repeating unit above 85% mole. The inorganic particle quencher additive may be of silicon dioxide, talc or the combinations thereof. A suitable inorganic particle quencher additive has an average diameter range of 0.01˜3.0 μm.

### CROSS-REFERENCE TO RELATED APPLICATIONS

This application claims priority to Korean Patent Application No. 2010-73748 filed Jul. 30, 2010, which is incorporated herein by reference in its entirety.

### FIELD OF THE INVENTION

The present invention relates to a polyphenylene sulfide synthetic hair filament and a process for preparing the same. More particularly, the present invention relates to mixing a quencher additive to a polyphenylene (PPS) resin to create a polyphenylene sulfide synthetic hair filament, and a process for preparing the same.

### BACKGROUND OF THE INVENTION

Synthetic hair filaments used in wigs necessitate and demand that the hair filaments be vivid in color, natural in gloss, light in weight, smooth to the touch, flexible, capable to form and maintain curls as well as the filaments to be flame retardant and be thermally resistant. As used herein, “flame retardancy” is described as being self-extinguishing and the melting polymer to be anti-dripping. As used herein, “thermal resistance” is described as the filaments exhibiting properties capable of withstanding conventional temperatures from dryers and curling irons such that shrinkage or modifications by conventional temperatures are absent. In order to substitute the functions of natural hair, thermal resistance and flame retardancy are important properties that synthetic hair filaments require.

Traditionally, synthetic hair filaments are made from PVC and modacrylic filaments that contain very high flame retardant properties. However, although these filaments are highly flame retardant, they have significant drawbacks where the filaments lack thermal resistance to hair dryers and hair irons in which hair damage occurs upon usage.

Generally, to solve the thermal resistant problem, synthetic hair filaments made by polyester which contain resin resistant to high temperature is developed and used. In particular, PET, PBT, PPT resin is used in polyester synthetic hair filaments. These filaments contain high thermal resistant properties, however are highly flammable and therefore require the addition of flame retardants in order for conventional synthetic hair usage. The technology adding flame retardants to polyester resin is widely known.

As referenced by Korean Patent Nos. 10-0714782 and 10-0577584, each of which are incorporated herein by reference in their entirety, the present inventors previously introduced the technology on flame retardant synthetic hair made with PET resin and bromine macromolecule flame retardants.

Moreover, International Application No. WO 2005/010247, which is incorporated herein by reference in its entirety, discloses a synthetic hair composition comprising 100 parts by weight PET, PBT, PPT resin and a 5 to 30 parts weight of a brominated epoxy flame retardant which has a 20,000 to about 80,000 number average molecular weight.

However, the disclosed flame retardant synthetic hair as described above, has a resin melting temperature of 220˜260° C., and because the softening temperature of the flame retardant is much lower, the polyester synthetic hair made by mixing the flame retardant has problems in which the thermal resistance temperature is much lower than the synthetic hair filaments made by polyester resin alone. Therefore, synthetic hair made by mixing resins has drawbacks in which the synthetic hair would not be able to withstand conventional temperatures of hair irons near 180° C. The problems associated with low resistance are destruction and modifications in the synthetic hair filaments where the outer appearance is damaged.

Generally, polyester flame retardant synthetic hairs are used alone or are made by mixing real hair filaments. However, these products have drawbacks in which hair styles such as curls are formed during manufacture by steam at 90˜120° C. or through air pressure and where curl formation is permanent such that consumers would require being at home or visiting a hair stylist in order to change hair styles.

The beauty instruments used in such cases are household hair irons or stove irons. Household hair irons include sensors whereby temperature control is accurate, however stove irons used in hair salons do not contain temperature sensors, thus accurate temperature control is difficult. Therefore, when a stove iron is used on polyester flame retardant synthetic hair that is less heat resistant than human hair, the heat may cause transformations or modifications to the synthetic hair. Therefore, there is a need for developing synthetic hair that allow stove irons to be used on wig products and carry better properties than human hair such as heat resistance properties.

In cases where hair styling is done in salons or homes on synthetic hair with polyester as the basic resin or in cases where synthetic hair is made by flame retardants, curls made at home or salons by hair irons form slower than human hair. The drawbacks of polyester synthetic hair is that in order to form curls, high temperatures are needed and further need to go through a cooling process after use of a hair iron. Therefore, problems exist to consumers with polyester synthetic hair, that in order to form curls to their hair, training of proper procedures which includes a procedure of undergoing a cooling period for forming proper curls needs to be learned.

Polyphenylene Sulfide resin has mostly been used as an ingredient in plastic housing, electronic parts, or optics. In addition, polyphenylene sulfide resin has been used as textile in dryer canvas or filters. However, polyphenylene sulfide resin has never been used for synthetic hair. The reason behind this is that the refractive index for PPS filaments reach 1.7 in which under light rays of the sun, the surface of the filament exhibit metallic sheen and is therefore not fit for synthetic hair filament purposes.

The present inventors developed and applied for the manufacture and process patents of synthetic hair filaments under Korean Patent Application No. 2008-60443 (filed Jun. 25, 2008). Described therein are synthetic hair filaments that use polyphenylene sulfide resin (PPS) as their basic resin with applying the right amount of a quencher additive, where flame retardant properties and thermal resistant properties are high such that curl forming may be done freely and in that sheen similar to human hair may be maintained.

However, it was discovered that PPS resin has drawbacks in which the weaving process working conditions are dependent on the melt index. Therefore, the present inventors invented a polyphenylene sulfide synthetic hair filament with PPS that contains an optimal melt index range where the working conditions during the spinning process can be maximized.

### EXEMPLARY OBJECTS OF THE INVENTION

In one objective, the present invention is to create a new material for synthetic hair filaments using polyphenylene sulfide resin which contain properties such as excellent thermal resistance, excellent flame retardancy, and excellent anti-dripping properties.

In another objective, the present invention is to provide a polyphenylene sulfide synthetic hair filament with excellent thermal resistance and flame retardancy that would not be affected and that would not deform by household irons or stove irons when used at conventional operating temperatures.

In a further objective, the present invention is to provide a polyphenylene sulfide synthetic hair filament where consumers may quickly form curls using hair irons or stove irons freely at home.

In a further objective, the present invention is to provide a polyphenylene sulfide synthetic hair filament that provides human like natural sheen made by adding a proper amount of inorganic particle quencher additives to a polyphenylene sulfide.

In a further objective, the present invention is to provide a PPS synthetic hair filament with a melt index of 280˜290° C., which is 30° C. more thermally resistant than conventional polyester synthetic hair filaments.

In a further objective, the present invention is to provide synthetic hair filaments that may be combined with human hair.

In a further objective, the present invention is to provide a polyphenylene sulfide synthetic hair filament that satisfies the basic demands of an excellent wig filament, such properties being, great sheen, vivid color, curl forming capabilities, curl longevity capabilities, curl elasticity, light in weight, minimal tangling properties, and qualities similar to human hair.

In a further objective, the present invention is to provide a method for preparing a polyphenylene sulfide synthetic hair filament that provides a non split end winding process phenomenon during the weaving process.

In a further objective, the present invention is to provide a wig prepared from the polyphenylene sulfide synthetic hair filament.

The present invention has for its object the features which are specified in the description below and in the claims that follow.

### SUMMARY OF THE INVENTION

The present invention provides a polyphenylene sulfide synthetic hair filament. The polyphenylene sulfide synthetic hair filament of the present invention comprises (A) a polyphenylene sulfide (PPS) resin; and (B) an inorganic particle quencher additive. The polyphenylene sulfide (PPS) resin (A) can include a 60˜110 melt index range of a polyphenylene sulfide (PPS) resin. The inorganic quencher additive is employed at 0.1˜2.0 parts by weight, to a 100 parts by weight of a PPS resin.

In one aspect of the present invention, the synthetic hair filament is 30 to about 80 dtex in size.

The polyphenylene sulfide (PPS) resin (A) can include above 85 mole % of a p-phenylene sulfide repeating unit.

The inorganic particle quencher additive comprises silicon dioxide, talc and the combinations thereof. A suitable average diameter of the inorganic particle quencher additive is within the range of 0.01˜3.0 μm.

In one aspect of the present invention, the polyphenylene sulfide synthetic hair filament may include at least one member selected from the group consisting of thermal stabilizers, light stabilizers, UV absorbing agents, fluorescent agents, antioxidants, anti-static agents, pigments, dyes, plasticizers, lubricants, flame retardants, flame retardant supplements, and inorganic fillers.

The present invention provides a wig prepared from the polyphenylene sulfide synthetic hair filament.

The present invention provides a method for preparing a polyphenylene sulfide synthetic hair filament. The method comprises providing a polyphenylene sulfide resin with a PPS based coloring masterbatch and an inorganic particle quencher additive composition, into a main feeder of an extruder, forming pellets; drying the pellets below 500 ppm moisture percentage; melting and spinning the dried pellets; and drawing the spinned undrawn filament 2 or 4 times using a drawing machine.

In another aspect of the present invention, the method may further include heating the drawn filament using a heating device at a temperature within the range of 160˜250° C.

In another aspect of the present invention, the method may further include heating the heated drawn filament within a 90˜160° C. range using a heating device.

These and other features, aspects, and advantages of the present invention will become better understood with reference to the following description and appended claims.

### DESCRIPTION OF EMBODIMENTS

The polyphenylene sulfide synthetic hair filament of the present invention can be prepared by employing a polyphenylene sulfide (PPS) resin (A) with a quencher additive (B).

### (A) Polyphenylene Sulfide (PPS) Resin

The basic resin in the present invention can be prepared from polyphenylene sulfide (PPS) resin. In general, PPS resin has flame retardant properties due to sulfur being inherent in the chemical composition, and further has thermal resistant properties due to its' high melting point of 285° C. Furthermore, since the crystalline properties of the PPS is high, PPS resin has special characteristics in which natural curls may form immediately with a hair iron, and without the need of a cooling process, compared to synthetic hair filaments made from polyester resin where a cooling process is needed.

In exemplary embodiments of the invention, the PPS resin in the present invention has a melt index (MI) within the range of 60˜110. In the case where the MI is below 60, the melt polymer flow is unsatisfactory, where the contained discharged filament does not easily stretch, and therefore is difficult to wind. Further, in the case where the MI is over 110, the melt polymer flow is too fast where winding is difficult. PPS resin can be worked on where the melt index is below 60 to about 50 and above 110 to about 200. However, in exemplary embodiments of the invention, in order to maintain working conditions where cutting and winding is not difficult, the PPS resin melt index range is 60˜110. In cases where the melt index of the PPS resin is below 50 or above 200, it's almost impossible to work on the resin.

The polyphenylene sulfide resin (A) of the present invention may be prepared by, without limitation, polycondensing p-dichlorobenzene with sodium sulfide.

In exemplary embodiments, the polyphenylene sulfide resin (A) can have a p-phenylene sulfide repeating unit as shown in Chemical Formula 1.

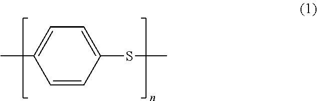

wherein the polyphenylene sulfide resin (A) can have a p-phenylene sulfide repeating unit above 85% mole, or the p-phenylene sulfide repeating unit is above 87% mole, or the p-phenylene sulfide repeating unit is above 90% mole.

In one embodiment of the invention, the polyphenylene sulfide resin may be prepared by copolymerizing less than 10% mole of trichlorobenzene to a p-dichloro benzene.

In one embodiment of the invention, the polyphenylene sulfide resin may be prepared by copolymerizing a unit of p-phenylene sulfide unit with a quantum unit of m-phenylene sulfide.

Although, other copolymerization mixtures of arylene sulfide or monomers capable of copolymerization may be used, in any case a repeating unit of p-phenylene sulfide unit containing above 85% weight of normal molecular structure is suitable. In the case where the synthetic hair filament is prepared with p-phenylene sulfide unit containing below 85% mole, the degree of strength will be weaker, the improper filament formation will not be suitable for the present invention, and filament formation is not formed well and further the orientation of the crystal drops with resins with higher crosslinking properties, and thus not suitable due to the weak strength.

### (B) Quencher Additive

The PPS resin of the present invention has a refractive index of 1.7 in the direction of the filament axis, and therefore under sunlight a strong metallic sheen is apparent and thus not suitable for synthetic hair filaments.

The quencher additive of the present invention may use an inorganic particle. The quencher additive is prepared by mixing inorganic particles with melted resin and is formed by the quencher additive's natural scattered reflection properties or by the microscopic swelling formed on the surface of the filament. One important aspect of the preparation method above is the selection of the type of particle, average size, and additives, especially with regards to the PPS, it is important to select excellent particles miscible with PPS. In the present invention, various particles such as barium sulfate, silicon dioxide, calcium carbonate, titanium dioxide, talc, antimony trioxide etc. are combined and tested by melting the above listed particles with PPS resin and the results show that silicon dioxide and talc does not make the color of the synthetic hair murky and therefore is suitable to be used as a quencher additive. Therefore, in the present invention, the inorganic particles of silicon dioxide, talc or the combinations thereof may be used.

The inorganic particle is used in an amount of about 0.1 to about 2 parts by weight, per 100 parts by weight of a PPS resin. If the quencher additive is used below 0.1 parts by weight, the quencher additive's effectiveness is weak; if the quencher additive is used above 2 parts by weight, the tint color of the synthetic hair is murky and therefore the vividness and the color beauty of the filament is not achieved; during the spinning and drawing process, the occurrence of single ply filaments may increase; swelling may occur on the surface and tangles may increase when combing; thus, is not suitable as synthetic hair filaments. In exemplary embodiments of the invention, the inorganic particle suitably is used in about 0.2 to about 1.5 parts by weight, or about 0.3 to about 1.0 parts by weight, per 100 parts by weight of a PPS resin.

In exemplary embodiments of the invention, the inorganic particle of the present invention has an average diameter range of 0.01-3.0 μm. In the case where the diameter is below 0.01 μm, during the compounding process, cohesion may occur during the spinning and drawing process, and there can be an increase in split end occurrences; in the case where the diameter exceeds 3.0 μm, swelling occurs on the filament surface where combing is defective; thus, is not suitable for the present invention.

In the present invention, in addition to the main constituents described above, if necessary, the usual additives such as, thermal stabilizers, light stabilizers, UV absorbing agents, fluorescent agents, antioxidants, anti-static agents, pigments, dyes, plasticizers, lubricants, flame retardants, flame retardant supplements, inorganic fillers etc, may be added. The additives above may be applied independently or may be combined and used with 2 or more combinations thereof.

The present invention provides a method for preparing a polyphenylene sulfide synthetic hair filament. The polyphenylene sulfide synthetic hair filament of the present invention can be prepared by combining an inorganic particle quencher additive and PPS coloring masterbatch chip to a polyphenylene sulfide resin and melt-extruding the composition in the form of pellets; the pellets are dried to a moisture percentage below 500 ppm; the dried pellets are melt spinned; and the melt spinned undrawn filament is drawn 2 to 4 times in size using a drawing machine.

The combined composition of the present invention may be prepared by a conventional process of melt extruding in the form of pellets. Biaxial extruder is a suitable extruder.

The PPS coloring masterbatch chip widely used is carbon black or pigments containing colored masterbatch chips.

The drying method of the present invention does not have special limitations, however, the conventional process is to dry at a temperature of 80˜180° C. The drying temperature is suitably at 95˜150° C. for about 3 to about 10 hours; or a drying time of about 4 to about 8 hours with a moisture percentage below 500 ppm; or a moisture percentage of 100 ppm is suitable.

The dried pellet of the present invention may be prepared by a conventional melt spinning method. In one embodiment of the invention, undrawn filaments may be prepared at the fore-end nozzle of the extruder by insertion. The confined spinning nozzle form is unlimited, for example, circular shaped, peanut shaped, star shaped, oval shaped, mid oval shaped may be used. The spinning temperature of the extruder cylinder can be 220˜350° C., or at about 250˜310° C.

In addition, the method may further include a method of drawing the melt spinned undrawn filament 2˜4 times the length by using a drawing machine. Drawing devices may include, without limitation, conventional heat drum drawing devices.

In one embodiment of the invention, the method may further include a method of heating in a heating device the drawn filament at a temperature range of 150˜250° C., or an additional heating in a heating device at a temperature of 200˜250° C. is suitable. The heating method and heating device may be prepared by conventional methods, and may be used by a person ordinary skilled in the art. In one embodiment of the invention, the heating process is done at a low tension state.

In one embodiment of the invention, the method may further include a method of a second heating of the drawn filament at a temperature range of 90˜160° C. in a heating device. Waves may be formed in the filaments during the relaxed unstressed state during the second heating process.

The final heated polyphenylene sulfide synthetic hair filament of the present invention is about 30 to about 80 dtex in size.

The polyphenylene sulfide synthetic hair filament of the present invention has properties such as the ability to form natural curls, withstand heat from hair irons at temperatures of 120˜230° C., high flame retardancy properties, anti-dripping properties, human hair like sheen properties, and vivid color properties suitable for wigs.

The present invention provides a wig prepared from the polyphenylene sulfide synthetic hair filament. The wig in the present invention may be prepared by a conventional process, and may be used by a person ordinary skilled in the art. In one embodiment of the invention, the polyphenylene sulfide synthetic hair filament may be used alone for manufacturing the wigs. In one embodiment of the invention, the polyphenylene sulfide synthetic hair filament combined with human hair may be suitable for manufacturing wigs, extensions and the like.

The present invention may be better understood by reference to the following examples which are intended for the purpose of illustration and are not to be construed as in any way limiting the scope of the present invention, which is defined in the claims appended hereto.

### EXAMPLES

### Examples 1-3

100 parts by weight PPS resin with a MI as shown in Table 1 below are spinned with a silicon dioxide quencher additive in an amount of 0.5˜1.0 parts by weight. The cylinder temperature of the spinning machine is 290° C., the head temperature is set at 313° C. with the use of a 160 hole nozzle to manufacture undrawn filament, and said filament is drawn at 3.8 times the size using a roller type drawing machine. The drawn filament is heated with a roller type heat treatment device with a temperature of 240° C. and is heated in a tension state. The 50 dtex synthetic hair filament is manufactured by relaxing and forming a slight wave in the filament in the non tension state in a heated box at a 150° C. temperature immediately thereafter.

### Comparative Examples

### Comparative Example 1

The components are mixed and extruded as Example 1 but the PPS with a MI of 40 is excluded from use.

### Comparative Example 2

The process is carried out as Example 2 but the quencher additive is excluded from use.

### Comparative Example 3

The components are mixed and extruded as Example 1 but the PPS with a MI of 600 is excluded from use.

The compositions and physical properties of the Examples 1-3 and Comparative Examples 1-3 are set forth in Table 1 below.

TABLE 1

| | Examples | | | Comparative Examples | | |
|---|---|---|---|---|---|---|
| | 1 | 2 | 3 | 1 | 2 | 3 |
| PPS Resin MI | 65 | 95 | 120 | 40 | 95 | 600 |
| Quencher | 1.0 | 1.0 | 0.5 | 0.5 | 0 | 1.0 |
| Additive | | | | | | |
| (parts by | | | | | | |
| weight) | | | | | | |
| Workability | ⊚ | ⊚ | ◯ | X | ⊚ | X |
| Brightness | ⊚ | ⊚ | ◯ | ◯ | X | ⊚ |
| Vividness of | ⊚ | ◯ | ◯ | ◯ | Δ | ◯ |
| Color | | | | | | |
| Curl Forming | ⊚ | ⊚ | ⊚ | — | ◯ | — |
| Curl | ⊚ | ◯ | ◯ | — | ◯ | — |
| Maintenance | | | | | | |
| Degree of | 3.3 | 3.4 | 3.1 | — | 3.0 | — |
| Strength (g/d) | | | | | | |
| Elongation (%) | 40 | 44 | 42 | — | 48 | — |

The MI of the PPS conforms to a discharged polymer gram number conforming to an ASTM D1238-86 at a temperature of 316° C., 5 kg measured weight that is discharged for 10 minutes. The Table 1 physical properties are measured by the following methods.

(1) workability: The split end rate is measured for 5 hours during the spinning process. (⊚: split end occurrence rate 0 times, ∘: split end occurrence rate 1 time, Δ: split end occurrence rate 2˜3 times, X: split end occurrence rate exceeding 4 times)

(2) brightness: focused filament bundle 80,000 dtex (160 units×50 dtex×10 strands) of synthetic hair filaments is cut at 10 cm and is evaluated for properties of brightness. (⊚: human hair like sheen, ∘: brighter sheen than human hair, Δ: low level sheen than human hair, X: low level and murky sheen than human hair)

(3) vividness of color: focused filament bundle 80,000 dtex (160 units×50 dtex×10 strands) of synthetic hair filaments is cut at 10 cm and is evaluated. The vividness is judged by 4 categories. (⊚: very vivid, ∘: vivid, Δ: less vivid, X: murky)

(4) curl forming: focused filament bundle 40,000 dtex (160 units×50 dtex×5 strands) of synthetic hair filaments is cut at 30 cm, clamped down, coiled around 3 times in an electric curler at a temperature of 180° C., maintained for 5 seconds, and taken out of the electric curler, and thereafter the condition before and after is evaluated. The curl forming is set forth in Table 1: ⊚: instance where the length (i.e. standard) of curl forming is identical to human hair, ∘: against the standard and loosening hair curl by 1˜2 cm, Δ: against the standard and loosening hair curl by 3˜4 cm, X: against the standard and loosening hair curl by 5 cm or more.

(5) curl maintenance: focused filament bundle 40,000 dtex (160 units×50 dtex×5 strands) of synthetic hair filaments is cut at 30 cm, clamped down, coiled around 3 times in an electric curler at a temperature of 180° C., maintained for 5 seconds, left alone after curl formation and thereafter the curl loss is evaluated. The specimen is hung down without weights at a relative humidity of 65% at room temperature of 20° C. for 24 hours and left alone and thereafter the curl loss is evaluated. The curl forming are set forth in Table 1: ⊚: less than 1 cm loosening hair curl, ∘: 2˜3 cm loosening hair curl, Δ: 4˜5 cm loosening hair curl, X: 6 cm and above loosening hair curl.

(6) Strength and Elongation: The LLoyd instrument's model LRX plus power elongation measuring system is used to measure. The measuring specimen is made by focusing 160 strands of filaments. The sensing device installs a 1 kN load cell, the specimen's scrap distance is 200 mm, elongation speed is 200 mm/second and the Strength and Elongation is measured. The same test is repeated 5 times and the average is obtained. The strength unit is g/d, the elongation unit was converted to a %.

As shown in Table 1, Examples 1-3, the PPS resin containing MI has a satisfactory fair weave and exhibits a filament that is sheen and vivid in color. On the other hand, as shown in Comparative Example 1, when the MI is very low the flow is poor and split ends are excessive where winding is difficult to achieve, and as shown in Comparative Example 3, when the MI is very high, the flow of the discharged filament is too quick that winding is impossible. Further, as shown in Comparative Example 2, when the quencher additive is not added, the spinning process is fair and satisfactory, and filament making is possible, however the brightness is too glittery and is not proper for wig purposes. The conditions in Comparative Examples 1 and 3 show that the winding of the undrawn filament is impossible, curl forming and filament properties are not measurable. The filament's sheen and vividness of color is understood by observing the characteristics of the discharged filament.

Many modifications and other embodiments of the present invention will come to mind of one skilled in the art to which this invention pertains having the benefit of the teachings presented in the foregoing descriptions. Therefore, it is to be understood that the present invention is not to be limited to the specific embodiments disclosed and that modifications and other embodiments are intended to be included within the scope of the appended claims.

What is claimed is:

1. A polyphenylene sulfide synthetic hair filament comprising:
(A) 100 parts by weight with a melt index range of 60˜110 of a polyphenylene sulfide (PPS) resin; and
(B) 0.1˜2.0 parts by weight of an inorganic quencher additive.

2. The polyphenylene sulfide synthetic hair filament of claim 1, wherein said synthetic hair filament size is about 30 to about 80 dtex.

3. The polyphenylene sulfide synthetic hair filament of claim 1, wherein said polyphenylene sulfide (A) has a p-phenylene sulfide repeating unit above 85% mole.

4. The polyphenylene sulfide synthetic hair filament of claim 1, wherein said inorganic quencher additive has an inorganic particle average diameter range of 0.01˜3.0 μm comprising silicon dioxide, talc, or the combination thereof.

5. The polyphenylene sulfide synthetic hair filament of claim 1, further comprising an additive chosen from a thermal stabilizer, a light stabilizer, a UV absorbing agent, a fluorescent agent, an antioxidant, an anti-static agent, a pigment, a dye, a plasticizer, a lubricant, a flame retardant, a flame retardant supplement, an inorganic filler, and any mixture thereof.

6. A method for preparing a polyphenylene sulfide synthetic hair filament comprising:
adding a combination made of PPS based coloring masterbatch and inorganic quencher additive to a polyphenylene sulfide (PPS) resin with a melt index range of 60˜110, into a melt extruder forming pellets;
drying the pellets to a moisture percentage below 500 ppm;
melt spinning the dried pellets; and
drawing the spinned undrawn filament 2 to 4 times in size using a drawing machine.

7. The method for preparing a polyphenylene sulfide synthetic hair filament of claim 6, wherein the inorganic particle quencher additive comprising 0.1˜2.0 parts by weight, per 100 parts by weight of a PPS resin is employed, and said inorganic particle has an average diameter range of 0.01˜3.0 μm.

8. The method for preparing a polyphenylene sulfide synthetic hair filament of claim 6, wherein said drawn filaments are heated in a heating device at a temperature range of 160˜250° C.

9. The method for preparing a polyphenylene sulfide synthetic hair filament of claim 8, wherein said drawn filaments are heated in a heating device at a temperature range of 90˜160° C.

10. A wig comprising a polyphenylene sulfide synthetic hair filament comprising:
(A) 100 parts by weight with a melt index range of 60˜110 of a polyphenylene sulfide (PPS) resin; and
(B) 0.1˜2.0 parts by weight of an inorganic quencher additive.

11. The wig of claim 10, wherein said synthetic hair filament size is about 30 to about 80 dtex.

12. The wig of claim 10, wherein said polyphenylene sulfide (A) has a p-phenylene sulfide repeating unit above 85% mole.

13. The wig of claim 10, wherein said inorganic quencher additive has an inorganic particle average diameter range of 0.01˜3.0 μm comprising silicon dioxide, talc, or the combination thereof.

14. The wig of claim 1, further comprising an additive chosen from a thermal stabilizer, a light stabilizer, a UV absorbing agent, a fluorescent agent, an antioxidant, an anti-static agent, a pigment, a dye, a plasticizer, a lubricant, a flame retardant, a flame retardant supplement, an inorganic filler, and any mixture thereof.
